(19) United States
(12) Patent Application Publication
(10) Pub. No.: US 2013/0312721 A1
(43) Pub. Date: Nov. 28, 2013

(54) IGNITION COIL FOR INTERNAL COMBUSTION ENGINE

(71) Applicant: DENSO CORPORATION, Kariya-city (JP)

(72) Inventor: Yuki YAMAUCHI, Kariya-shi (JP)

(73) Assignee: DENSO CORPORATION, Kariya-city (JP)

(21) Appl. No.: 13/900,928

(22) Filed: May 23, 2013

(30) Foreign Application Priority Data
May 24, 2012 (JP) 2012-118758

(51) Int. Cl. F02P 3/01

(52) U.S. Cl. CPC F02P 3/01
USPC 123/634

(57) ABSTRACT

An ignition coil for an internal combustion engine is provided which includes a body with a metallic hollow cylinder and a high-voltage portion joined to an end of the cylinder. The hollow cylinder has a primary winding and a secondary winding disposed therein. The high-voltage portion is made of a resin material and includes an inner cylinder and an outer cylinder disposed outside the inner cylinder through a gap. The inner cylinder has disposed therein a conductive elastic member which establishes an electric connection to a spark plug. A resinous insulator is disposed in a gap between the first and second cylinders. The resinous insulator is higher in insulation strength than the resin material of the high-voltage portion, thereby improving the degree of electric insulation between the metallic hollow cylinder and the conductive elastic member.

### CROSS REFERENCE TO RELATED DOCUMENT

The present application claims the benefit of priority of Japanese Patent Application No. 2012-118758 filed on May 24, 2012, the disclosure of which is totally incorporated herein by reference.

### BACKGROUND OF THE INVENTION

1. Technical Field

This disclosure relates generally to an ignition coil for use in producing an electric spark in a spark plug for use in internal combustion engines.

2. Background Art

The so-called stick coil is known as an ignition coil for internal combustion engines. The stick coil typically includes voltage step-up windings disposed inside a cylindrical body (i.e., a shell) to be inserted into a plug hole of an internal combustion engine. The stick coil also includes a high-voltage portion coated with resin material such as polyphenylene sulfide (PPS) and a head coated with resin material such as polybutylene terephthalate (PBT) in order to withstand severe conditions such as high-temperature conditions within the plug hole of the engine. The head is located far away from the combustion chamber of the engine. The PPS withstands hydrolysis and has a high electrical insulation strength. The PBT is high in flame resistance.

The diameter of the plug hole of the internal combustion engine into which the ignition coil is to be installed tends to be decreased in order to meet requirements to reduce the size of the internal combustion engine. For example, Japanese Patent First Publication No. 2003-309029 teaches techniques for making the cylindrical body and the high-voltage portion of the ignition coil from metal, not the PPS in order to improve the mechanical strength of an outer shell of the ignition coil without having to increase the thickness thereof. The making of the outer shell from metal causes the cylindrical body to have the same function as those of an outer core disposed inside an inner circumference of the cylindrical body, so that the cylindrical body works as a portion of the outer core of a secondary coil. The outer core is made of a plurality of cylinders overlapping each other coaxially. This permits the cylinders of the outer core to be reduced in number and the cylindrical body to be decreased in diameter thereof.

The metal-made periphery of the high-voltage portion of the ignition coil serving to apply a high-voltage to a spark plug, however, causes high-voltage, as stepped up by the primary and secondary coils, to be applied to a conductive elastic body through which the high-voltage is delivered to the spark plug, which can lead to electrical breakdown of an insulating material provided inside of the high-voltage portion, thus resulting in an unintended short between the conductive elastic body and the outer periphery of the high-voltage portion.

If the outer periphery of the high-voltage portion is made from resin, but only the same insulating material as that of the high-voltage portion exists in a minimum linear distance between the conductive elastic body and the outer periphery of the metal-made cylindrical body, there is a high possibility that the breakdown occurs inside the high-voltage portion, thus resulting in an unintended electric short between the outer periphery of the cylindrical body and the conductive elastic body. Such a short will result in a lack in application of voltage, as produced by the ignition coil, to the spark plug, which leads to a failure in operation of the internal combustion engine.

### SUMMARY

It is therefore an object to provide an improved structure of an ignition coil for use with a spark plug installed in an internal combustion engine which is high in reliability in operation to avoid an unintended electrical connection to the spark plug.

According to one aspect of an embodiment, there is provided an ignition coil for use with an internal combustion engine. The ignition coil comprises: (a) a body including a metallic hollow cylinder which has a length with a first end and a second end; (b) a primary coil and a secondary coil which are disposed inside the cylindrical body and work to create high voltage to be applied to a spark plug; (c) a resinous head which is press-fit on the second end of the cylinder and has a first resinous insulator disposed therein, the head also including an electric connector for establishing an electric connection with an external device; (d) a high-voltage portion which is joined to the first end of the cylinder and has joined thereto a plug cap in which a spark plug is to be fitted, the high-voltage portion being made of resin material and having disposed therein a conductive elastic member which is to be electrically connected to the spark plug, the high-voltage portion including an inner cylinder and an outer cylinder disposed outside the inner cylinder through a gap, the inner cylinder having the conductive elastic member disposed therein, the outer cylinder being press-fit in the first end of the cylinder; and (e) a second resinous insulator disposed in the gap between the first and second cylinders of the high-voltage portion, the second resinous insulator having a higher insulation strength or resistance than the resin material of the high-voltage portion.

The second resinous insulator is, as described above, interposed between the first and second cylinders of the high-voltage portion, thereby improving the degree of electric insulation between the metal-made cylinder and the conductive elastic member. The arrangement of the second resinous insulator between the first and second cylinders avoids a short circuit occurring at the closest approach between the conductive elastic member and the cylinder. In other words, the second resinous insulator functions to create an electric path which bypasses the second resinous insulator. Such a path is increased in distance, which results in a lowered probability of an unintended electrical connection between the conductive elastic member and the cylinder.

The high-voltage portion is formed to be separable from the body, thus facilitating ease with which the ignition coil is suited to the geometry or dimension of a plug hole of the internal combustion engine by changing or modifying the high-voltage portion.

The cylinder of the body is simple in shape and thus permitted to be machined easily using extrusion techniques, which also allows the thickness thereof to be reduced.

### BRIEF DESCRIPTION OF THE DRAWINGS

The present invention will be understood more fully from the detailed description given hereinbelow and from the accompanying drawings of the preferred embodiments of the invention, which, however, should not be taken to limit the invention to the specific embodiments but are for the purpose of explanation and understanding only.

In the drawings:

FIG. 1 is a longitudinal sectional view which illustrates an ignition coil of an embodiment;

FIG. 2 is a longitudinal sectional view which illustrates a high-voltage portion of the ignition coil of FIG. 1;

FIG. 3 is a partially enlarged longitudinal sectional view which illustrates a portion of a head casing of the ignition coil of FIG. 1;

FIG. 4 is a partially enlarged sectional view which illustrates an outer cylinder of a high-voltage portion of the ignition coil of FIG. 1;

FIGS. 5(A), 5(B), 5(C), and 5(D) are sectional views which represent a sequence of steps to make a cylindrical shell of the ignition coil of FIG. 1; and

FIG. 6 is a graph which represents relations of thickness of a cylindrical shell of an ignition coil to a ratio of an amount of magnetic flux in an outer core to that in a center core and a ratio of an amount of magnetic flux in the cylindrical shell to that in the center core in the second embodiment.

### DESCRIPTION OF THE PREFERRED EMBODIMENTS

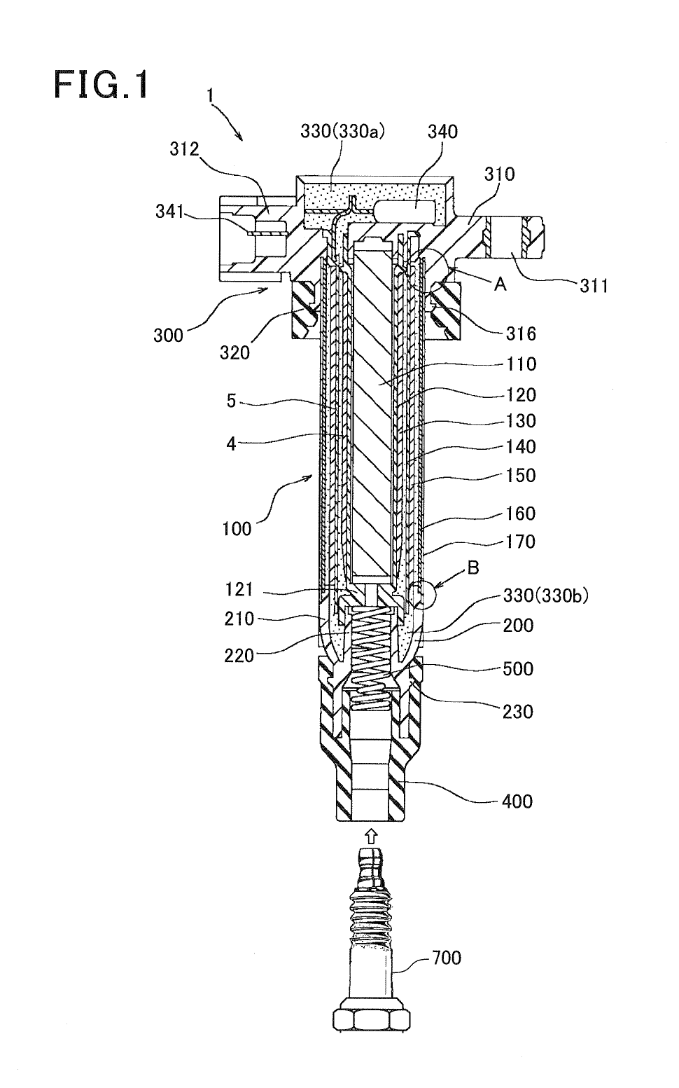

Referring to the drawings, wherein like reference numbers refer to like parts in several views, particularly to FIG. 1, there is shown an ignition coil 1 for use with a spark plug 700 installed in an internal combustion engine. The ignition coil 1 includes a hollow cylindrical body 100. The body 100 also includes a metallic hollow cylindrical shell 170, as will be described later in detail. In the following discussion, an end or a portion of the body 100 (i.e., the cylindrical shell 170) closer to a combustion chamber of the internal combustion engine will be referred to as a top end or a top portion (also called a first end or a first portion), while an end or a portion of the body 100 (i.e., the cylindrical shell 170) farther away from the combustion chamber will be referred to as a base end or a base portion (also called a second end or a second portion).

### First Embodiment

FIG. 1 is a longitudinal sectional view which illustrates the ignition coil 1 of the first embodiment.

The ignition coil 1 includes the body 100, a head 300, and a high-voltage portion 200. The body 100, as described above, includes the cylindrical shell 170 in which a primary coil (also called primary winding) 5 and a secondary coil (also called secondary winding) 4 are disposed coaxially. The cylindrical shell 170 has a given length extending in an axial direction of the ignition coil 1. The head 300 is press-fit on a base portion of the body 100 and includes a head casing 310 in which an igniter 340 is disposed and which has an electrical connector 312. The igniter 340 works to control energization or de-energization of the primary coil 5. The electrical connector 312 is equipped with connector pins (i.e., terminals) 341 for electrical connections to an external device. The high-voltage portion 200 is a portion of the ignition coil 1 through which high-voltage, as stepped up by the primary coil 5 and the secondary coil 4, is applied to the spark plug 700. The high-voltage portion 200 is press-fit in a top portion (i.e., an opening) of the body 100 and has retained therein a conductive elastic member 500 to be electrically joined to the spark plug 700. The joint to the spark plug 700 is typical, and explanation thereof in detail will be omitted here.

The head casing 310 is formed in the shape of a box and made from resin material such as polybutylene terephthalate (PBT). The head casing 310 is equipped with a plug mount 311, the connector 312, and the igniter 340. The plug mount 311 is a portion of the head casing 310 with a hole through which a bolt is fastened to mount the ignition coil 1 on the internal combustion engine. The connector 312, as described above, works to establish an electrical connection to an external device such as a power supply. The igniter 340 works to energize or de-energize the primary coil 5.

A coil seal rubber 320 is fit on an outer periphery of a base side opening of the head casing 310 to avoid ingress of water into the plug hole of the internal combustion engine. The fitting of the coil seal rubber 320 on the head casing 310 is accomplished with mechanical engagement with a barbed flange 316 of a cylindrical fitting portion 313 of the head casing 310.

An insulator 330 is disposed inside the ignition coil 1 to electrically insulate component parts within the ignition coil 1. Specifically, the insulator 330 is made from a thermosetting resin such as epoxy resin. The thermosetting resin is put from an upper end of the head casing 310 inside the ignition coil 1 and then flows from inside the head 300, to a clearance between the secondary coil 4 and the primary coil 5 within the body 100, and to a gap between an outer cylinder 210 and an inner cylinder 220 of the high-voltage portion 200. After the inside of the ignition coil 1 is filled with the thermosetting resin, thermosetting resin is solidified to complete the insulator 330, thereby electrically insulate the igniter 340, the primary coil 5, the secondary coil 4, the outer cylinder 210, and the inner cylinder 220 from each other. A portion of the insulator 330 disposed inside the head 300 (i.e., the head casing 310) will also be referred to as a first resinous insulator 330a, while a portion of the insulator 330 disposed in the gap between the outer cylinder 210 and the inner cylinder 220 of the high-voltage portion 200 will also be referred to as a second resinous insulator 330b.

The body 100, as described above, has the secondary coil 4, the primary coil 5, and a hollow cylindrical outer core 160 disposed inside the cylindrical shell 170. The secondary coil 4 is equipped with a cylindrical secondary spool 120 disposed around an outer periphery of a cylindrical center core 110 made from soft magnetic material and a secondary winding 130 wound around the secondary spool 120. Similarly, the primary coil 5 is equipped with a cylindrical primary spool 140 disposed around an outer periphery of the secondary coil 4 and a primary winding 150 wound around the primary spool 140. The outer core 160 is constructed to have a structure such as that disclosed in, for example, Japanese Patent First Publication No. 10-303047, filed on Nov. 13, 1998, assigned to the same assignee as that of this application, the disclosure of which is incorporated therein by reference. Specifically, the outer core 160 is made of an assembly of a plurality of hollow cylinders which are coaxially overlapped with each other in a radius direction thereof. Each of the hollow cylinders is made of a non-oriented magnetic steel plate with a longitudinal slit. The hollow cylinders are so arranged that the slits coincide with each other in the radius direction of the hollow cylinders. The outer core 160 is disposed around the periphery of the primary coil 5.

The cylindrical shell 170 is formed by a hollow cylinder made from metal. Specifically, the cylindrical shell 170 is made of, for example, a cylindrical rolled steel and has a thickness of 0.2 mm to 0.6 mm.

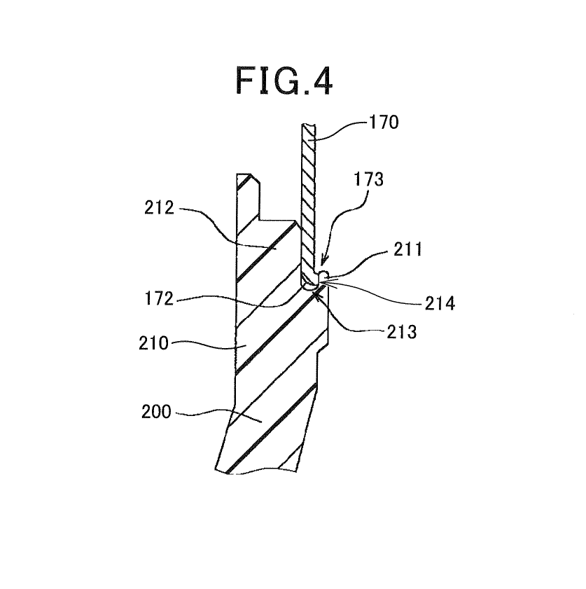

The cylindrical shell 170 also has a plated layer made of, for example, nickel (Ni) or chromium (Cr). It is preferable that the plated layer is made of metallic material containing Ni. The plate layer does not occupy a portion of the cylindrical shell 170 with which an outer protrusion 211 of the high-voltage portion 200, as illustrated in FIG. 4, is placed in in direct contact.

The cylindrical shell 170 has a given length extending in the axial direction of the ignition coil 1 and, as clearly illustrated in FIGS. 3 and 4, includes an inner bent end 171 and an outer bent end 172. The inner bent end 171 is an end (i.e., the second end, as referred to an introductory part of explanation of this embodiment) of the cylindrical shell 170 which is closer to the head 300 and curved in a radially inward direction of the ignition coil 1 (i.e., the cylindrical shell 170). Similarly, the outer bent end 172 is an end (i.e., the first end) of the cylindrical shell 170 which is closer to the high-voltage portion 200 and curved in an outward direction of the ignition coil 1 (i.e., inwardly from the cylindrical shell 170). The bent end 172 is, as can be seen in FIG. 4, is fit in the high-voltage portion 200.

The secondary spool 120, as illustrated in FIG. 1, includes a coil retainer 170 which joins the inner cylinder 220 of the high-voltage portion 200 and the secondary spool 120 together and also serves to align the longitudinal center line common to the secondary coil 4 and the center core 110 with that of the conductive elastic member 500 disposed in the high-voltage portion 200.

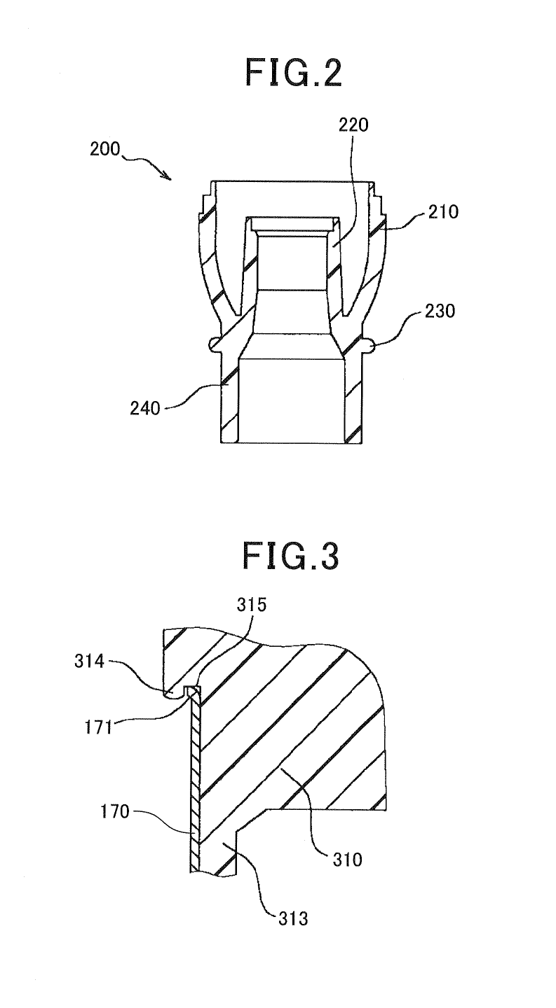

FIG. 2 is a longitudinal sectional view which illustrates the high-voltage portion 200 of the ignition coil 1. The high-voltage portion 200 is of a cylindrical shape and press-fit in the top end of the body 100. The high-voltage portion 200 is made from a flame-retardant resin such as polyphenylene sulfide (PPS) which withstands hydrolysis and has a high insulating property. The high-voltage portion 200 includes the inner cylinder 220, the outer cylinder 210, and a lower cylindrical extension 240. The inner cylinder 220 firmly retains therein the conductive elastic member 500 made of a conductive wire shaped spirally. The outer cylinder 210 is press-fit in the end of the cylindrical shell 170. The lower cylindrical extension 240 has a cap lock 230 by which a plug cap 400 is joined firmly to the high-voltage portion 200. The cap lock 230 is formed in the shape of an annular protrusion.

The conductive elastic member 500 is to be connected electrically at a top end thereof to the spark plug 700 to apply high-voltage, as stepped up by the primary coil 5 and the secondary coil 4, to the spark plug 700.

The inner cylinder 220, as descried above, has the conductive elastic member 500 disposed therein. Specifically, the inner cylinder 200 serves to position the conductive elastic member 500 and also to grip the outer periphery of the conductive elastic member 500 to align the longitudinal center line thereof with that of the body 100. The outer cylinder 210 is of a hollow cylindrical shape and joined at a top end thereof to a top end of the inner cylinder 220 and a base end of the lower cylindrical extension 240.

The plug cap 400 is made of an insulating elastic material such as rubber and shaped to grasp the spark plug 700 tightly at an inner surface thereof and works to electrically insulate metallic parts of the internal combustion engine from the high voltage applied to the spark plug 700.

The assembling of the ignition coil 1 is accomplished by press-fitting the head 300 and the high-voltage portion 200 on and in the ends of the body 100, respectively.

Specifically, a mechanical fit is established between the base end of the cylindrical shell 170 and the head casing 310 and between the top end of the cylindrical shell 170 and the outer cylinder 210 of the high-voltage portion 200. Specifically, the cylindrical fitting portion 313 of the head casing 310 is fit at the inner periphery thereof on the outer periphery of the base end of the cylindrical shell 170. The high-voltage portion 200, as illustrate in FIG. 4, has a cylindrical small-diameter portion 212 which serves as a fitting portion press-fit at an outer periphery thereof in the top opening of the cylindrical shell 170.

FIG. 3 is a partially enlarged longitudinal sectional view which illustrates a portion of the head casing 310 which is fit on the outer periphery of the cylindrical shell 170.

The head casing 310 includes the cylindrical fitting portion 313 and an annular groove 315. The cylindrical fitting portion 313 is, as described above, fit on the outer periphery of the base end (i.e., the second end) of the cylindrical shell 170 of the body 100. The head casing 310 has an annular inner protrusion 314, as illustrated in FIG. 3, which projects in the inward direction of the head casing 310, that is, to the inner wall of the base end of the head casing 310. The annular groove 315 is a recess (which will also be referred to as a fitting recess below) formed in a corner of an inner shoulder of the head casing 310 to define the inner protrusion 314. The inner bent end 171 of the cylindrical shell 170 is fit in the annular groove 315, so that the inner protrusion 314 of the head casing 310 is placed in abutment with the inner bent end 171 (i.e., the inner periphery of the cylindrical shell 170). The cylindrical fitting portion 313 has an inner wall extending in the axial direction of the body 100 closer to the top end of the body 100 (i.e., more downwardly in FIG. 3) than the inner protrusion 314 does. In other words, the cylindrical fitting portion 313 (i.e., the inner peripheral wall thereof fit on the outer periphery of the cylindrical shell 170) is made longer in length than the inner protrusion 314 in the lengthwise direction of the cylindrical shell 170. The inner wall of the cylindrical fitting portion 313 with which the cylindrical shell 170 is placed in direct contact has a length of 3.2mm or more in the lengthwise direction of the cylindrical shell 170.

FIG. 4 is a partially enlarged longitudinal sectional view which illustrates the outer cylinder 210 of the high-voltage portion 200 which is fit on the cylindrical shell 170.

The outer cylinder 210 includes the small-diameter portion 212 and an annular groove 213. The small-diameter portion 212 is, as described above, fit in the inner periphery (i.e., the inner wall) of the cylindrical shell 170 of the body 100. The outer cylinder 210 has, as described above, the outer protrusion 211 which extends to the outer wall or outer periphery of the top end of the cylindrical shell 170. The annular groove 213 is a recess (which will also be referred to as a fitting recess below) formed in a corner of an outer shoulder of the outer cylinder 210 to define the outer protrusion 211. The outer bent end 172 of the cylindrical shell 170 is fit in the annular groove 213, so that the outer protrusion 211 of the outer cylinder 210 is placed in abutment with the outer bent end 172 (i.e., the outer periphery of the cylindrical shell 170). The small-diameter portion 212 extends from a major body of the outer cylinder 210 in the axial direction of the body 100 closer to the base end of the body 100 (i.e., more upwardly in FIG. 4) than the outer protrusion 211. The small-diameter portion 212 serves as an inner periphery-fitting portion press-fit in the top opening of the cylindrical shell 170 and has a length of 1.0 mm or more. Specifically, the outer wall of the small-diameter portion 212 with which the inner wall of the cylindrical shell 170 is placed in direct contact has a length of 1.02 mm or more in the lengthwise direction of the cylindrical shell 170.

Before the head casing 310 is fitted on the cylindrical shell 170, the outer diameter of the cylindrical shell 170 is greater than the inner diameter of the cylindrical fitting portion 313 of the head casing 310, while the outer diameter of the small-diameter portion 212 of the high-voltage portion 200 is greater than the inner diameter of the cylindrical shell 170. A difference between the outer diameter of the cylindrical shell 170 and the inner diameter of the cylindrical fitting portion 313 is greater than or equal to 0.01 mm and smaller than or equal to 0.25 mm. Such a diameter difference will be referred to as an interference a below. Similarly, the interference a between the outer diameter of the small-diameter portion 212 and the inner diameter of the cylindrical shell 170 is greater than or equal to 0.01 mm and smaller than or equal to 0.25 mm (i.e., 0.01 mm a 0.25 mm).

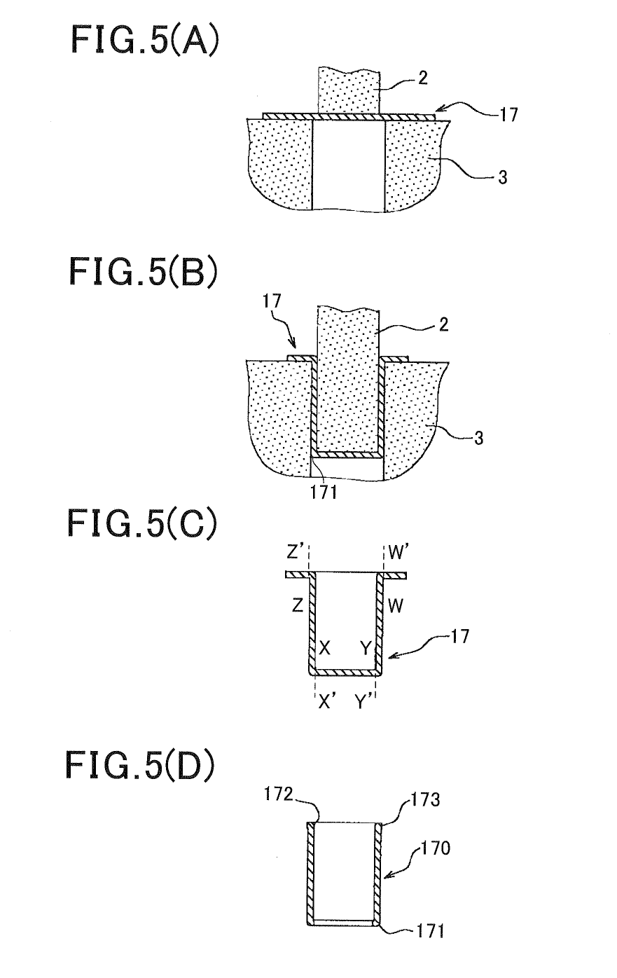

How to produce the cylindrical shell 170 will be described below. FIGS. 5(A) to 5(D) are longitudinal sectional views which show a sequence of steps to make the cylindrical shell 170.

First, a rolled metallic plate 17 is, as illustrated in FIG. 5(A), disposed horizontally between a die 3 with a cylindrical hole and a cylindrical punch 2. Next, the punch 2 is moved, as illustrated in FIG. 5(B), downward to the die 3 which is fixed. The punch 2 thrust the metallic plate 17 into the hole of the die 3, thereby forming the metallic plate 17 into a cup shape with a flange. When the metallic plate 17 is pressed downward by the punch 2, a surface of the metallic plate 17 which is fixed by the punch 2, that is, placed in direct contact with the bottom of the punch 2 and a surface of the metallic plate 17 which is placed in direct contact with an annular upper corner of the hole of the die 3 are usually subjected to compressive stress, while a surface of the metallic plate 17 which is not placed in direct contact with the punch 2, that is, opposite to the surface of the bottom of the punch 2 and a surface of the metallic plate 17 which is opposite to the upper corner of the hole of the die 3 are subjected to tensile stress. This causes an annular corner 171 to be formed between the bottom wall and the side wall of the metallic plate 17.

Subsequently, the flange of the metallic plate 17 which is formed into the shape of a cup in the steps of FIGS. 5(A) and 5(B) is cut or sheared in a direction from Z′ to Z and W′ to W, as illustrated in a longitudinal cross section view of FIG. 5(C). The bottom of the metallic plate 17 is also punched out in a direction from X′ to X and Y′ to Y, as illustrated in the longitudinal cross section view of FIG. 5(C), thereby completing, as illustrated in FIG. 5(D), the cylindrical shell 170 with the inner bent end 171 and the outer bent end 172. As apparent from the above discussion, the inner bent end 171 has an outer curved or rounded surface continuing to an outer surface of a side wall of the cylindrical shell 170, while the outer bent end 172 has an inner curved or rounded surface continuing to an inner surface of the side wall of the cylindrical shell 170.

The direction Z′ to Z and W′ to W, as illustrated in FIG. 5(C), is oriented at right angles to a plane extending perpendicular to the axial direction of the metallic plate shaped into a hollow cylinder through an upper opening of the metallic plate 17. Similarly, the direction X′ to X and Y′ to Y is oriented at right angles to a plane extending perpendicular to the axial direction of the metallic plate through the circular bottom of the metallic plate 17.

The beneficial effects of the ignition coil 1 will be described below.

The high-voltage portion 200 includes the inner cylinder 220, the outer cylinder 210 which is press-fit in the cylindrical shell 170 and the inner cylinder 220 in which the conductive elastic member 500 is retained. The insulator 330 occupies between the outer cylinder 210 and the inner cylinder 220. The insulator 330, as described already, includes the first resinous insulator 330a and the second resinous insulator 330b. The second resinous insulator 330b is disposed in the gap between the outer cylinder 210 and the inner cylinder 220. The insulator 330 (i.e., the first and second resinous insulators 330a and 330b) is made of resin which is higher in degree of electrical insulation than that of the high-voltage portion 200. It is preferable that at least the second resinous insulator 330b disposed between the outer cylinder 210 and the inner cylinder 220 is higher in degree of electrical insulation than that of the high-voltage portion 200.

The inner cylinder 220 of the high-voltage portion 200 serves to grasp the outer periphery of the conducive elastic member 500 to align the center axis thereof with that of the secondary coil 4 in the body 100, thereby ensuring the stability in electric connection therebetween.

The misalignment of the center axis of the conductive elastic member 500 from that of the secondary coil 4 may result in a failure in electric joint of the top end of the secondary coil 4 to the conductive elastic member 500. Additionally, the misalignment of the center axis of the spark plug 700 from that of the conductive elastic member 500 may also result in a failure in establishing an electric path extending from the conducive elastic member 500 to the spark plug 700. The structure of the high-voltage portion 200 is, as descried above, shaped to eliminate such problems.

The insulator 330 is, as described above, disposed between the inner cylinder 220 and the outer cylinder 210.

The high voltage, as stepped up by the primary coil 5 and the secondary coil 4 in the body 100, is applied to the conductive elastic member 500, so that an unintended electric short may occur between the conductive elastic member 500 and the metal-made cylindrical shell 170. Such a short usually occupies a minimum distance between the conductive elastic member 500 and the cylindrical shell 170. If the high-voltage portion 200 is made only from polyphenylene sulfide (PPS) and does not have the inner cylinder 220 and the outer cylinder 210, an electric short may result in occurrence of breakdown inside the high-voltage portion 200 within the minimum distance between the conductive elastic member 500 and the cylindrical shell 170.

In order to avoid the above drawback, the high-voltage portion 200 is shaped to have a double-wall structure, that is, include the outer cylinder 210 and the inner cylinder 220 which extend from a base portion (i.e., an upper portion, as viewed in FIG. 2) of the cylindrical extension 240. The inner cylinder 220 is located away from the outer cylinder 210 through an annular air gap. The air gap is filled with the insulator 330 (i.e., the second resinous insulator 330b) which is made from an insulating resin such as epoxy resin higher in electrical insulation property (i.e., insulation strength) than PPS. The insulator 330 (i.e., the second resinous insulator 330b) functions to avoid the short occurring along the minimum distance between the conductive elastic member 500 and the cylindrical shell 170. In other words, the insulator 330 functions to create an electric short which bypasses the insulator 330 between the conductive elastic member 500 and the cylindrical shell 170. Such a short is increased in distance, which results in a lowered probability of an unintended electrical connection between the conductive elastic member 500 and the cylindrical shell 170.

The outer cylinder 210 is, as described above, made from a flame-retardant resin, and thus high in resistance to heat, as emitted from the internal combustion engine. The ignition coil 1 is, thus, designed to ensure the stability in applying voltage to the spark plug 700 and minimize a failure in producing sparks in the spark plug 700. The ignition coil 1 of this embodiment is highly reliable in operation.

The head casing 310 includes the cylindrical extension 313 which has an inner wall contacting the outer wall of the cylindrical shell 170. The head casing 310 also includes the groove 315. The groove 315 defines the inner protrusion 314 which contacts the inwardly bent end of the cylindrical shell 170 (i.e., a portion of the inner wall of the cylindrical shell 170). In other words the head casing 310 is shaped to grasp the outer and inner peripheries of the cylindrical shell 170. The cylindrical fitting portion 313 extends closer to the top end of the body 100 than the inner protrusion 314 is.

The groove 315 also serves to cover burrs formed on the edge of the cylindrical shell 170 in a machining process, as described in FIGS. 5(A) to 5(D), thereby avoiding any injury of an operator during assembling work of the ignition coil 1 to improve safety thereof. The cylindrical fitting portion 313, as described above, has the inner peripheral wall which is fit on the outer peripheral wall of the cylindrical shell 170. The inner peripheral wall of the cylindrical fitting portion 313 is made long in length to increase an area contacting the outer peripheral wall of the cylindrical shell 170, thus minimizing the entry of water into the body 100 and also avoiding leakage of the insulator 330 outside the body 100 to provide the ignition coil 1 that is highly airtight.

The inner cylinder 210, as clearly illustrated in FIG. 4, has the small-diameter portion 212 and the groove 213. The small-diameter portion 212 has the outer peripheral wall which is fit on the inner peripheral wall of the cylindrical shell 170. The groove 213 defines the outer protrusion 211 whose inner wall is fit on the outer peripheral wall of the cylindrical shell 170. The small-diameter portion 211 (i.e., the outer peripheral wall thereof fit on the inner periphery of the cylindrical shell 170) is made longer in length than the outer protrusion 211 in the lengthwise direction of the cylindrical shell 170 and extends closer to the base end of the body 100 than the outer protrusion 211 is.

The groove 213 serves to cover burrs formed on the edge of the cylindrical shell 170 in the machining process, as described in FIGS. 5(A) to 5(D), thereby avoiding any injury of the operator during assembling work of the ignition coil 1 to improve safety thereof. The groove 213 also works to secure the alignment of the cylindrical shell 170 with the longitudinal center line of the ignition coil 1.

The small-diameter portion 211 (i.e., the outer peripheral wall thereof) is, as described above, made long in length, thereby increasing an area contacting the inner peripheral wall of the cylindrical shell 170, thus minimizing the entry of water into the body 100 and also avoiding leakage of the insulator 330 outside the body 100 to provide the ignition coil 1 that is high in airtightness.

The cylindrical shell 170, as described above in FIGS. 3 and 4, has the inner bent end 171 and the outer bent end 172. The inner bent end 171 is the end of the cylindrical shell 170 which is closer to the head 300 and curved in the inward direction of the ignition coil 1. Similarly, the outer bent end 172 is the end of the cylindrical shell 170 which is closer to the high-voltage portion 200 and curved in the outward direction of the ignition coil 1. The bent end 172 is, as can be seen in FIG. 4, is fit in the high-voltage portion 200.

The inward and outward curving of the ends of the cylindrical shell 170 facilitates ease with which the inner bent end 171 and the outer bent end 172 are hermetically fitted into the groove 315 of the head casing 310 and the groove 213 of the high-voltage portion 200 without getting stuck on the inner wall of the cylindrical fitting portion 313 and the outer wall of the small-diameter portion 212, respectively. Such getting stuck usually results in the need for strongly thrusting the cylindrical shell 170 into the grooves 315 and the 213, leading to scratches on the inner wall of the cylindrical fitting portion 313 and the outer wall of the small-diameter portion 212, in the worst case, to breakage of the head casing 310 and the outer cylinder 210 of the high-voltage portion 200. The above structure of the cylindrical shell 170 alleviates such a problem.

The cylindrical shell 170, as described above, has the plated layer. The plate layer does not occupy the portion 214 of the cylindrical shell 170 with which the outer protrusion 211 of the high-voltage portion 200, as illustrated in FIG. 4, is placed in in direct contact. The plated layer serves to avoid oxidization of the cylindrical shell 170 to decrease the possibility of formation of rust thereon. The non-plated portion 214 establishes hermetic contact between the cylindrical shell 170 and the groove 213 of the high-voltage portion 200, thereby minimizing the entry of water into the body 100 and also avoiding leakage of the insulator 330 outside the body 100 to provide the ignition coil 1 that is high in airtightness.

The plated layer of the cylindrical shell 170 is preferably made from nickel (Ni). The nickel enhances the above advantageous effect.

The cylindrical shell 170 is made of a hollow metallic cylinder. Use of lightweight metal for the cylindrical shell 170 results in a decrease in overall weight of the ignition coil 1. Alternatively, use of metal such as iron which is high in magnetic property enables the cylindrical shell 170 to have the same function as that of the outer core 160. This permits the number of plates stacked to form the outer core 160 to be decreased and also permits the ignition coil 1 to be reduced in diameter.

The making of the cylindrical shell 170 with metal which is high in magnetic property results in a decrease in leakage flux that is a magnetic flux not needed to step up the voltage through the secondary coil 4 and the primary coil 5 to ensure an amount of magnetic flux satisfying performance requirements for the ignition coil 1.

The outer core 160 is made of soft magnetic material such as either a grain-oriented magnetic steel plate or a non-oriented magnetic steel plate. A typical outer core is made of a stack of grain-oriented magnetic plates in which internal magnetic fluxes are arrayed regularly. The grain-oriented magnetic steel plate has properties which permit magnetic fluxes oriented in a given direction to pass and block magnetic fluxes oriented in other directions. Accordingly, the outer core is usually disposed to have the direction of internal magnetic fluxes aligned with the axial direction of the body of the ignition coil to ensure the amount of magnetic fluxes contributing to the voltage-stepping up ability of the ignition coil. Alternatively, the non-oriented magnetic steel plate has properties in which the direction of magnetic flux is not fixed and offers the advantage that it is easy and inexpensive to machine, but the voltage-stepping up ability thereof is lower than the grain-oriented magnetic steel plate.

The ignition coil 1 of this embodiment is designed to have the rolled steel-made cylindrical shell 170 disposed around the outer core 160 made of the non-oriented magnetic steel plates. The cylindrical shell 170, thus, assumes the function of the outer core 160, thereby decreasing the amount of leakage flux and permitting the number or thickness of the staked plates of the outer core 160 to be decreased without sacrificing the performance of the ignition coil 1. This also allows the ignition coil 1 to be reduced in overall size thereof. The cylindrical shell 170 is formed in the shape of a simple hollow cylinder and thus permitted to made to have a decreased wall thickness within a range of 0.1 mm to 0.6 mm in which there are less adverse effects resulting from an iron loss which will arise from a flow of electric current canceling the magnetic flux within the cylindrical shell 170. This ensures 70% or more of the magnetic flux in the center core 110, which satisfies the performance requirements for the ignition coil 1, within the cylindrical shell 170.

### Second Embodiment

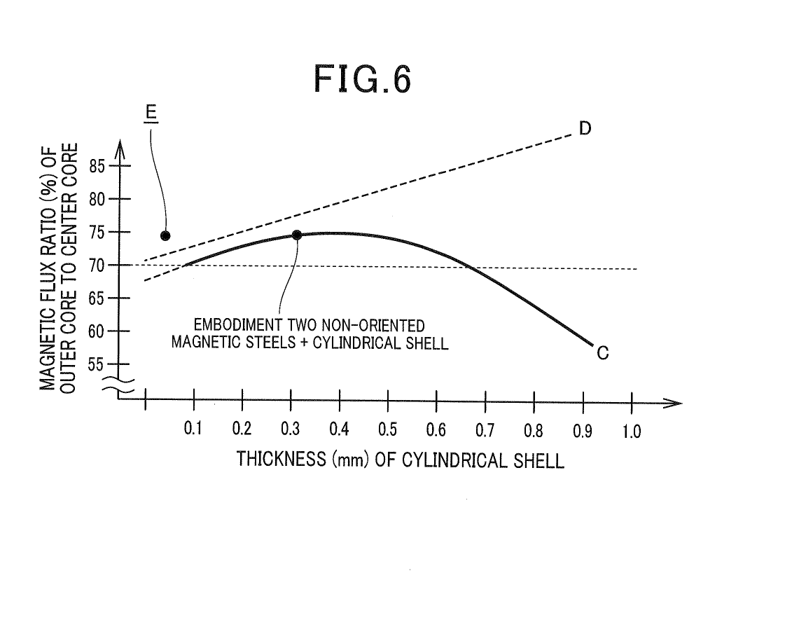

We performed tests to analyze relations of the thickness of the cylindrical shell 170 to a ratio of an amount of magnetic flux in the outer core 160 to that in the center core 110 and a ratio of an amount of magnetic flux in the cylindrical shell 170 to that in the center core 110. We prepared two types of test samples: the first type in which the outer core 160 is made up of four cylindrical grain-oriented magnetic steel plates each having a thickness of 0.23 mm (i.e., a total thickness is 0.92 mm), and the other in which the outer core 160 is made up of tow cylindrical non-oriented magnetic steel plates each having a thickness of 0.35 mm, and the cylindrical shell 170 which is made of a cold-rolled steel having a thickness of 0.3 mm is wrapped about the outer core 160 (i.e., a total thickness of an assembly of the outer core 160 and the cylindrical shell 170 is 1.00 mm). We measured the above magnetic flux ratios on the test samples. Results of the measurement are shown in FIG. 6.

In FIG. 6, a line C represents a ratio of a total amount of magnetic flux in the outer core 160 and the cylindrical shell 170 to an amount of magnetic flux in the center core 110 for different thicknesses of the cylindrical shell 170 A line D represents a ratio of an amount of magnetic flux in the cylindrical shell 170 to the center core 110 for different thicknesses of the cylindrical shell 170 when there is no iron loss. A line E represents a ratio of an amount of magnetic flux of the outer core 160 made up of the four cylindrical grain-oriented magnetic steel plates to that of the center core 110 for different thicknesses of the cylindrical shell 170.

The graph of FIG. 6 shows that too great a thickness of the cylindrical shell 170 results in an increase in area of the cylindrical shell 170 where the magnetic flux is oriented in directions other than the axial direction of the body 100, which will enhance the activity of the iron loss to decrease the amount of magnetic flux therein because the direction of magnetic flux in the rolled steel is not fixed. An interval between the lines C and D in the vertical axis of the graph in FIG. 6 indicates the iron loss. The graph shows that an increase in thickness of the cylindrical shell 170 will result in an increase in iron loss.

Typically, the outer core 160 is required to produce 70% or more (i.e., a flux content) of the amount of magnetic flux in the center core 110. In the test samples in which the outer core 160 is made of four cylindrical grain-oriented magnetic steel plates, the outer core 160 establishes approximately 75% of the amount of magnetic flux in the center core 110 which is great enough to satisfy the required amount of magnetic flux.

In the test samples equipped with the outer core 16 which is made of the two non-oriented magnetic steels is wrapped about the cylindrical shell 170, the cylindrical shell 170 may need to be decreased in thickness thereof because an increase in thickness of the cylindrical shell 170 results in an increase in iron loss, so that the amount of magnetic flux in the outer core 160 may be 70% of that in the center core 110.

However, when the configuration of the cylindrical shell 170 is complex, it results in a difficulty in machining it, which may lead to breakage of the cylindrical shell 170. In order to alleviate such a problem, it is necessary for the cylindrical shell 170 to have a thickness of 0.8 mm to 1.0 mm or more, however, it results in an increase in iron loss and deterioration in performance of the ignition coil 1.

In order to satisfy the required performance the ignition coil 1 is, therefore, designed to have the cylindrical shell 170 whose thickness t is within a range of 0.1 mm to 0.6 mm (i.e., 0.1 mm≦t≦0.6 mm).

While the present invention has been disclosed in terms of the preferred embodiments in order to facilitate better understanding thereof, it should be appreciated that the invention can be embodied in various ways without departing from the principle of the invention. Therefore, the invention should be understood to include all possible embodiments and modifications to the shown embodiments which can be embodied without departing from the principle of the invention as set forth in the appended claims.

What is claimed is:

1. An ignition coil for an internal combustion engine comprising:
a body including a metallic hollow cylinder which has a length with a first end and a second end;
a primary coil and a secondary coil which are disposed inside the cylindrical body and work to create high-voltage to be applied to a spark plug;
a resinous head which is press-fit on the second end of the metallic hollow cylinder and has a first resinous insulator disposed therein, the head also including an electric connector for establishing an electric connection with an external device;
a high-voltage portion which is joined to the first end of the cylinder and has joined thereto a plug cap in which a spark plug is to be fitted, the high-voltage portion being made of resin material and having disposed therein a conductive elastic member which is to be electrically connected to the spark plug, the high-voltage portion including an inner cylinder and an outer cylinder disposed outside the inner cylinder through a gap, the inner cylinder having the conductive elastic member disposed therein, the outer cylinder being press-fit in the first end of the cylinder; and
a second resinous insulator disposed in the gap between the first and second cylinders of the high-voltage portion, the second resinous insulator having a higher insulation strength than the resin material of the high-voltage portion.

2. An ignition coil as set forth in claim 1, further comprising an outer core disposed around an outer periphery of the primary coil, the outer core being made of an non-oriented magnetic material, and wherein the hollow cylinder is made from metal containing a main component of iron and has a thickness t which meets a relation of 0.1 mm≦t≦0.6 mm.

3. An ignition coil as set forth in claim 1, wherein the head includes a fitting portion which is press-fit on an outer periphery of the second end of the cylinder and a fitting recess which is formed in an inner wall of the head to define a protrusion which projects to an inner periphery of the second end of the cylinder, and wherein the outer cylinder of the high-voltage portion includes a fitting portion which is press-fit on an inner periphery of the first end of the cylinder and a fitting recess which is formed in an outer wall of the outer cylinder to define a protrusion which is placed in contact with an outer periphery of the first end of the cylinder.

4. An ignition coil as set forth in claim 3, wherein the fitting portion of the head is longer than the fitting protrusion of the head in a lengthwise direction of the cylinder, and wherein the fitting portion of the outer cylinder is longer than the fitting protrusion of the outer cylinder in the lengthwise direction of the cylinder.

5. An ignition coil as set forth in claim 4, wherein the cylinder includes an inner bent end as the second end fit in the head and an outer bent end as the first end fit on the high-voltage portion, the inner bent end being curved in an inward direction of the cylinder, the outer bent end being curved outwardly from the cylinder.

6. An ignition coil as set forth in claim 3, wherein an outer diameter of the cylinder is greater than an inner diameter of the fitting portion of the head by a value d, while an outer diameter of the fitting portion of the high-voltage portion is greater than an inner diameter of the cylinder by the value d, and wherein the value d is selected to meet a relation of 0.01 mm≦a≦0.25 mm.

7. An ignition coil as set forth in claim 3, wherein the cylinder has a plated layer which does not occupy a portion of the cylinder with which the protrusion of the outer cylinder of high-voltage portion is placed in direct contact.

8. An ignition coil as set forth in claim 7, wherein the plated layer is made from nickel.

9. An ignition coil as set forth in claim 1, wherein the second resinous insulator is identical in material with the first resinous insulator.

10. An ignition coil as set forth in claim 9, wherein the second resinous insulator and the first resinous insulator are formed integrally with each other.
